(19) United States
(12) Patent Application Publication
(10) Pub. No.: US 2022/0062908 A1
(43) Pub. Date: Mar. 3, 2022

(54) CARRYING MODULE AND DETECTION DEVICE CONTAINING SAME

(71) Applicant: Hangzhou AnYu Technologies Co., Ltd., Hangzhou (CN)

(72) Inventors: Xianjun ZHANG, Hangzhou (CN); Jianhong LING, Hangzhou (CN); Yong FANG, Hangzhou (CN); Zhaokang XUAN, Hangzhou (CN)

(21) Appl. No.: 17/233,482

(22) Filed: Apr. 17, 2021

(30) Foreign Application Priority Data
Sep. 3, 2020 (CN) 202010916252.4

(51) Int. Cl. B01L 7/00; B01L 9/00; G01N 21/64; G01N 21/01

(52) U.S. Cl. CPC B01L 7/52; B01L 9/00; G01N 21/645; G01N 21/6428; B01L 2300/18; G01N 2021/0112; G01N 2021/6484; G01N 21/01

(57) ABSTRACT

A carrying module and a detection device containing the same. The carrying module includes a main body. A top of the main body is provided with a plurality of cavities. The plurality of cavities is configured to accommodate a sample. A side of the main body is provided with a plurality of channels. The plurality of channels communicates with the plurality of cavities in one-to-one correspondence.

### CROSS-REFERENCE TO RELATED APPLICATIONS

This application claims the benefit of priority from Chinese Patent Application No. 202010916252.4, filed on Sep. 3, 2020. The content of the aforementioned application, including any intervening amendments thereto, is incorporated herein by reference in its entirety.

### TECHNICAL FIELD

This application relates to detection techniques, and more particularly to a carrying module and a detection device containing the same.

### BACKGROUND

Quantitative real-time polymerase chain reaction (PCR) can be used to quantitatively analyze deoxyribonucleic acid (DNA) templates, which is of great significance to molecular biology study and medical research. Compared to the ordinary PCR, a fluorescent labeled probe or a fluorescent dye is introduced in the quantitative real-time PCR to monitor the PCR process in real time, and then an unknown template can be quantitatively analyzed using a standard curve. Specifically, a sample is added to a transparent tube, and then the transparent tube is transferred to a module. A fluorescent signal emitted from the sample is detected by a detection unit. Generally, the module is vertically provided with a through hole, in which the transparent tube is inserted. The detection unit detects the fluorescent signal generated by the sample from a bottom of the module to obtain the total amount of the PCR product. Currently, a bottom of the transparent tube is generally a gate structure. However, due to the large thickness, the gate structure will easily affect a light penetrate rate of the sample, causing the detection unit to fail to detect the fluorescent signal generated by the sample accurately. As a consequence, it cannot provide a reliable quantitative analysis of the DNA template.

### SUMMARY

An object of this application is to provide a carrying module and a detection device containing the same to overcome the defect in the prior art that a thicker gate structure will affect a light penetrate rate of a sample, thereby causing a detection unit to fail to accurately detect the generated fluorescent signals.

Technical solutions of the present disclosure are described as follows.

In a first aspect, this application provides a carrying module, comprising:

a main body;

wherein a top of the main body is provided with a plurality of cavities; the plurality of cavities is configured to accommodate a sample; a side of the main body is provided with a plurality of channels; and the plurality of channels communicates with the plurality of cavities in one-to-one correspondence.

In an embodiment, the plurality of cavities comprises a plurality of first cavities and a plurality of second cavities; the plurality of first cavities and the plurality of second cavities are both provide along a length of the main body; the plurality of first cavities and the plurality of second cavities are provided in parallel and are misaligned; the plurality of channels is provided along the length of the main body; and the plurality of channels alternately communicates with the plurality of first cavities and the plurality of second cavities in one-to-one correspondence.

In an embodiment, the plurality of first cavities is arranged spaced apart; the plurality of second cavities is arranged spaced apart; and the plurality of first cavities and the plurality of second cavities are alternately arranged.

In an embodiment, the plurality of channels comprises a plurality of first channels and a plurality of second channels; the plurality of first channels and the plurality of second channels are both provided spaced apart; the plurality of first channels and the plurality of second channels are alternately provided; the plurality of first channels communicates with the plurality of first cavities in one-to-one correspondence; and the plurality of second channels communicates with the plurality of second cavities in one-to-one correspondence.

In an embodiment, the main body comprises a front portion and a rear portion connected with each other; the front portion comprises an upper portion and a lower portion connected with each other; the upper portion comprises a plurality of first cylinders connected in sequence; a plurality of first sub-cavities with a top opening is provided on the plurality of first cylinders, respectively; the lower portion comprises a plurality of second sub-cavities spaced apart; the plurality of first sub-cavities communicates with the plurality of second sub-cavities in one-to-one correspondence to form the plurality of first cavities; the rear portion comprises a plurality of second cylinders connected in sequence; the plurality of second cylinders is respectively provided with a top opening to form the plurality of second cavities; and the plurality of channels is provided on a side of the lower portion.

In a second aspect, this application further provides a detection device, comprising:

the carrying module;

a plurality of light guide columns;

a temperature control component;

a frame;

a detecting unit; and

a drive unit;

wherein the plurality of light guide columns is provided in the channels communicating with the plurality of second cavities in one-to-one correspondence; and the plurality of light guide columns is configured to guide fluorescent signals generated by samples in the plurality of second cavities to a side of the main body, respectively;

the temperature control component is configured to heat or cool the carrying module to adjust a temperature of the samples;

the detecting unit is configured to detect the fluorescent signals generated by the samples; and

the drive unit is provided on the frame; the drive unit is configured to drive the detecting unit to move along the length of the main body to enable the detecting unit to detect fluorescent signals generated by the samples in the plurality of first cavities and/or in the plurality of second cavities.

In an embodiment, the detection device further comprises a guide member; and the guide member is configured to guide the detecting unit to move along the length of the main body when the detecting unit is driven by the drive unit.

In an embodiment, the guide member comprises a guide rail and a sliding block provided on the guide rail; the sliding block is configured to move along the guide rail; the guide rail is provided adjacent to the front portion of the main body and in parallel with the side of the main body; the detecting unit is provided on the sliding block; the drive unit drives the detecting unit to move to enable the detecting unit to drive the sliding block to move on the guide rail such that the detecting unit moves along the length of the main body.

In an embodiment, the drive unit comprises a first driving wheel, a second driving wheel, a transmission belt and a motor; the first driving wheel, the second driving wheel and the transmission belt are provided on a top of the frame; the motor is provided on a bottom of the frame; the transmission belt is provided on the first driving wheel and the second driving wheel; the motor is connected to the first driving wheel; the transmission belt is connected to the detecting unit; the motor is configured to drive the first driving wheel to rotate; the first driving wheel drives the transmission belt to move such that the transmission belt drives the detecting unit to move, driving the sliding block to move along the guide rail.

In an embodiment, the detection device further comprises a limit assembly; and the limit assembly is configured to limit a movement range of the detecting unit along the guide rail.

In an embodiment, the limit assembly comprises a first limit part and a second limit part; and the first limit part and the second limit part are provided on two sides of the guide rail, respectively, to limit the movement range of the detecting unit along the guide rail.

In an embodiment, the detection device further comprises a heat dissipater; the heat dissipater is connected to the frame; the temperature control component is provided on the heat dissipater; the carrying module is provided on a side of the temperature control component away from the heat dissipater; and the heat dissipater is configured to perform heat dissipation on the temperature control component.

In an embodiment, the detection device further comprises a pressing frame; the pressing frame is provided on the carrying module and is connected to the heat dissipater; and the pressing frame is configured to enable the carrying module, the temperature control component and the heat dissipater to be in close contact.

Compared to the prior art, the present disclosure has the following beneficial effects.

In this application, a top of a main body is provided with a plurality of cavities, and a side of the main body is provided with a plurality of channels. The plurality of channels communicates with the plurality of cavities in one-to-one correspondence. When a detecting unit detects a sample in a cavity through a corresponding channel on the side of the main body, since thicknesses of other parts of a transparent tube are less than that of a gate, the other parts will not affect a light penetrate rate of the sample, enabling the detecting unit to detect fluorescent signals generated by the sample accurately. As a consequence, it can provide a reliable quantitative analysis of the DNA template.

### BRIEF DESCRIPTION OF THE DRAWINGS

The disclosure will be described in detail below with reference to the drawings to make advantages and features of the present disclosure clearer. Obviously, presented in the drawings are only some embodiments of the present disclosure, and are not intended to limit the disclosure. It should be understood that other drawings made by those of ordinary skill in the art based on the content disclosed herein without making any creative efforts should fall within the scope of the disclosure.

FIG. 1 is a front view of a carrying module according to an embodiment of the present disclosure.

FIG. 2 is a rear view of the carrying module according to an embodiment of the present disclosure.

FIG. 3 is a perspective view of a detection device according to an embodiment of the present disclosure.

FIG. 4 is an exploded view of the detection device according to an embodiment of the present disclosure.

In this drawings: 100, detection device; 10, carrying module; 1, main body; 11, front portion; 111, upper portion; 1111, first cylinder; 1112, first sub-cavity; 112, lower portion; 1121, second sub-cavity; 12, rear portion; 121, second cylinder; 2, cavity; 21, first cavity; 22, second cavity; 3, channel; 31, first channel; 32, second channel; 20, light guide; 30, temperature control component; 40, frame; 50, detecting unit; 51, fixed frame; 52, sensor element; 60, drive unit; 61, first driving wheel; 62, second driving wheel; 63, transmission belt; 64, motor; 70, guide member; 71, guide rail; 72, sliding block; 80, limit assembly; 81, first limit part; 82, second limit part; 90, heat dissipater; and 110, pressing frame.

### DETAILED DESCRIPTION OF EMBODIMENTS

The disclosure will be further described clearly and completely below with reference to the accompanying drawings and embodiments. Obviously, the described embodiments are only some embodiments of the present invention, are not intended to limit the disclosure. It should be understood that other embodiments obtained by those of ordinary skill in the art based on the content disclosed herein without making creative efforts should fall within the scope of the present disclosure.

It should be noted that all directional indications (such as up, down, left, right, front, rear, etc.) in the embodiment of the present disclosure are only used to explain the relative position relationship, movement situation, etc. between the components under a certain posture (as shown in the attached figures). If the specific posture changes, the directional indication changes accordingly.

In addition, as used herein, terms “first”, “second” and the like are only descriptive, and cannot be understood as indicating or implying their relative importance or implicitly indicating the number of technical features indicated. Thus, the features defined as “first” or “second” may explicitly or implicitly indicate that at least one of the features is included. The term “and/or” includes any one of or any combination of two or more of the listed items. In addition, various embodiments can be combined with each other, in a manner that those skilled in the art can implement the present invention, and the combination of the embodiments that is expected in an inappropriate way will not be considered as falling within the scope of the present invention.

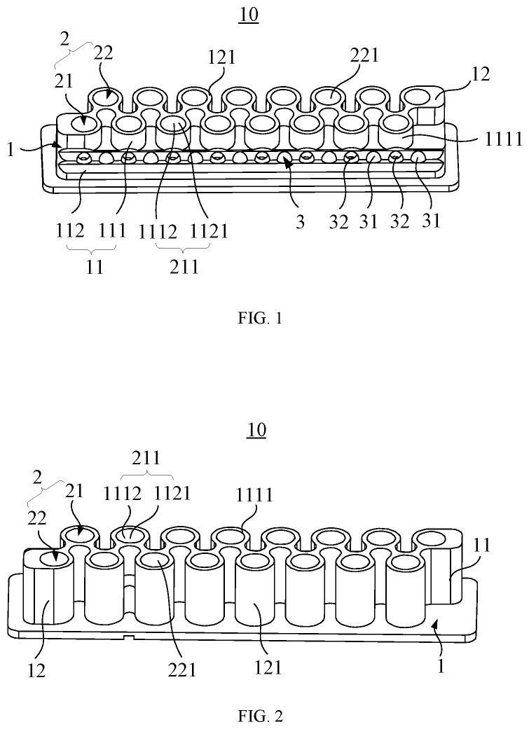

As shown in FIGS. 1-2, illustrated is a carrying module 10, including a main body 1. A top of the main body 1 is provided with a plurality of cavities 2. The plurality of cavities 2 is configured to accommodate a sample. A side of the main body 1 is provided with a plurality of channels 3. The plurality of channels 3 communicates with the plurality of cavities 2 in one-to-one correspondence.

The top of the main body 1 is provided with the plurality of cavities 2, and the side of the main body 1 is provided with the plurality of channels 3. The plurality of channels 3 communicates with the plurality of cavities 2 in one-to-one correspondence. When a detecting unit 50 detects a sample in a cavity through a corresponding channel 3 on the side of the main body 1, since a thicknesses of other parts of a transparent tube are less than that of a gate, the other parts will not affect a light penetrate rate of the sample, enabling the detecting unit 50 to detect fluorescent signals generated by the sample accurately. As a consequence, it can provide a reliable quantitative analysis of the DNA template.

The plurality of cavities 2 includes a plurality of first cavities 21 and a plurality of second cavities 22. The plurality of first cavities 21 and the plurality of second cavities 22 are both provide along a length of the main body 1. The plurality of first cavities 21 and the plurality of second cavities 22 are provided in parallel and are misaligned. The plurality of channels 3 is provided along the length of the main body 1. The plurality of channels 3 alternately communicates with the plurality of first cavities 21 and the plurality of second cavities 22 in one-to-one correspondence. Such misaligned arrangement enables the detecting unit 50 to detect the fluorescent signals generated by the samples in the plurality of second cavities 22 through the corresponding channels 3. Moreover, there is no need to arrange the plurality of channels 3, the detecting unit 50 and a drive unit at two sides of the carrying module 10, allowing for a simplified structure and improved reliability.

The number of the first cavities 21 and the second cavities 22 are both eight. In other embodiments, the number can be adjusted according to actual requirements.

The misaligned arrangement is explained in detail. The plurality of first cavities 21 is arranged spaced apart. The plurality of second cavities 22 is arranged spaced apart. The plurality of first cavities 21 and the plurality of second cavities 22 are alternately arranged.

The plurality of channels 3 includes a plurality of first channels 31 and a plurality of second channels 32. The plurality of first channels 31 and the plurality of second channels 32 are both provided spaced apart. The plurality of first channels 31 and the plurality of second channels 32 are alternately provided. In some embodiments, a total of sixteen channels are provided, where eight first channels 31 and eight second channels 32 are alternately arranged. The plurality of first channels 31 communicates with the plurality of first cavities 21 in one-to-one correspondence. The plurality of second channels 32 communicates with the plurality of second cavities 22 in one-to-one correspondence. Such alternate arrangement can accommodate two or more rows of channels in one row of space to reduce a thickness of the carrying module 10, thereby reducing a volume of the carrying module 10. The carrying module 10 with a small volume can be quickly heated and cooled, so that the reaction can be accelerated to improve detection efficiency.

The main body 1 includes a front portion 11 and a rear portion 12 connected with each other. The front portion 11 includes an upper portion 111 and a lower portion 112 connected to each other. The upper portion 111 includes a plurality of first cylinders 1111 connected in sequence. A plurality of first sub-cavities 1112 with a top opening is provided on the plurality of first cylinders 1111, respectively. The lower portion 112 includes a plurality of second sub-cavities 1121 spaced apart. The plurality of first sub-cavities 1112 communicates with the plurality of second sub-cavities 1121 in one-to-one correspondence to form the plurality of first cavities 21. The rear portion 12 includes a plurality of second cylinders 121 connected in sequence. The plurality of second cylinders 121 is respectively provided with a top opening to form the plurality of second cavities 22. The plurality of channels 3 is provided on a side of the lower portion 112. Such arrangement can reduce the volume of the carrying module 10. The carrying module 10 with the small volume can be quickly heated and cooled, so that the sample can react quickly to improve the detection efficiency of the sample.

The plurality of first cavities 21 are provided near the side of the main body 1. A distance of the plurality of first cavities 21 from the side of the main body 1 is smaller than that of the plurality of second cavities 22 from the side of the main body 1. Such arrangement enables the detecting unit 50 to detect the fluorescent signals generated by the samples in the plurality of first cavities 21 through the corresponding plurality of channels 3, which can avoid a high cost caused by adding a light guide column 20 to guide the fluorescent signals to the side of the main body 1, so that the carrying module 10 has a brilliant application prospect.

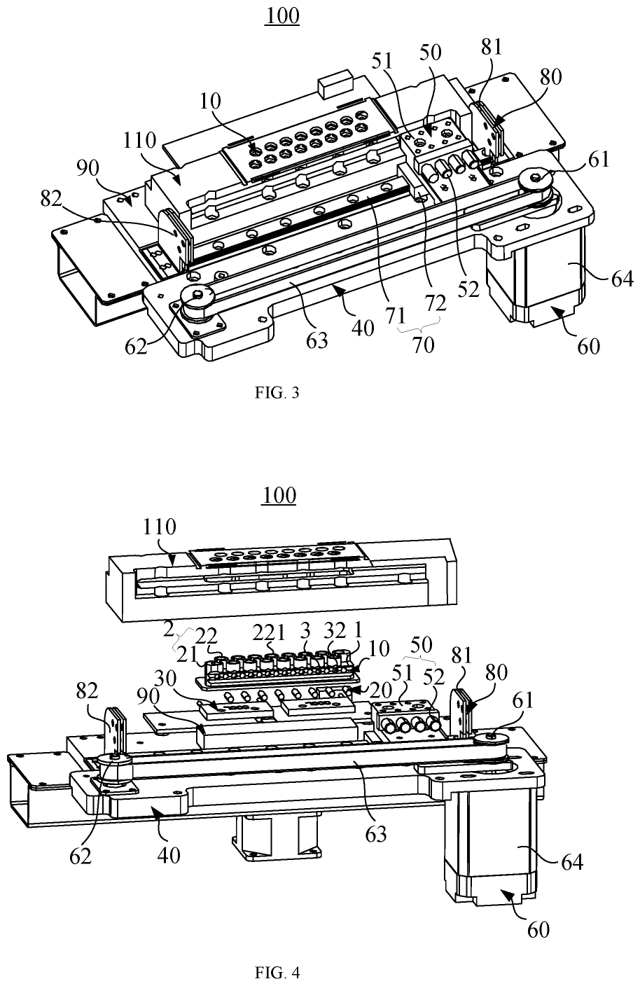

As show in FIGS. 3-4, illustrated is a detection device 100, including a carrying module 10 in any of the above embodiments, a plurality of light guide columns 20, a temperature control component 30, a frame 40, a detecting unit 50 and a drive unit 60. The plurality of light guide columns 20 is provided in the channels 3 communicating with the plurality of second cavities 22 in one-to-one correspondence.

The plurality of light guide columns 20 is configured to guide the fluorescent signals generated by the samples in the plurality of second cavities 22 to the side of the main body 1, respectively. The temperature control component 30 is configured to heat or cool the carrying module 10 to adjust a temperature of the samples. The detecting unit 50 is configured to detect the fluorescent signals generated by the samples. The drive unit 60 is provided on the frame 40. The drive unit 60 is configured to drive the detecting unit 50 to move along the length of the main body 1 to enable the detecting unit 50 to detect fluorescent signals generated by the samples in the plurality of first cavities 21 and/or in the plurality of second cavities 22. Specifically, the light guide columns 20 are provided in the second channels 32 communicating with the second cavities 22 in one-to-one correspondence.

The temperature control component 30 is a semiconductor chilling plate.

The detection device 100 further includes a guide member 70. The guide member 70 is configured to guide the detecting unit 50 to move along the length of the main body 1 when the detecting unit 50 is driven by the drive unit 60. The guiding effect of the guide member 70 enables the detecting unit 50 to move along the side of the main body 1, so that the detecting unit 50 can accurately detect the fluorescent signals generated by the samples, allowing for improved detection accuracy.

The guide member 70 includes a guide rail 71 and a sliding block 72 provided thereon. The sliding block 72 is configured to move along the guide rail 71. The guide rail 71 is provided adjacent to the front portion of the main body 1 and in parallel with the side of the main body 1. The detecting unit 50 is provided on the sliding block 72. The drive unit 60 drives the detecting unit 50 to move to enable the detecting unit 50 to drive the sliding block 72 to move on the guide rail 71, such that the detecting unit 50 moves along the length of the main body 1.

The drive unit 60 includes a first driving wheel 61, a second driving wheel 62, a transmission belt 63 and a motor 64. The first driving wheel 61, the second driving wheel 62 and the transmission belt 63 are provided on a top of the frame 40. The motor 64 is provided on a bottom of the frame 40. The transmission belt 63 is provided on the first driving wheel 61 and the second driving wheel 62. The motor 64 is connected to the first driving wheel 61. The transmission belt 63 is connected to the detecting unit 50. The motor 64 is configured to drive the first driving wheel 61 to rotate. The first driving wheel 61 drives the transmission belt 63 to move, such that the transmission belt 63 drives the detecting unit 50 to move, driving the sliding block 72 to move along the guide rail 71.

The detecting unit 50 includes a fixed frame 51 and sensor elements 52 provided thereon. One end of the fixed frame 51 is connected with the transmission belt 63, and the other end is provided on the sliding block 72.

In an embodiment, there are four sensor elements 52, where the four sensor elements 5 are sequentially provided on the fixed frame 51 from left to right, and the four sensor elements 5 are driven by the motor 64 to move along the length of the main body 1. When moving to the positions respectively corresponding to the first four channels 3, the four sensor elements 52 can simultaneously detect the fluorescence signals generated by the samples in the four cavities 2 corresponding to the first four channels 3, respectively, so as to improve the detection efficiency of the detection device 100. It should be understood that the number of the sensor elements 52 can be adjusted according to actual requirements.

In an embodiment, the detection device 100 further includes a limit assembly 80. The limit assembly 80 is configured to limit a movement range of the detecting unit 50 along the guide rail 71. The limit assembly 80 can prevent the detecting unit 50 from falling off from the guide rail 71 to improve the operation reliability of the detection device 100.

The limit assembly 80 includes a first limit part 81 and a second limit part 82. The first limit part 81 and the second limit part 82 are provided on two sides of the guide rail 71, respectively, to limit the movement range of the detecting unit 50 along the guide rail 71.

In an embodiment, the detection device 100 further includes a heat dissipater 90. The heat dissipater 90 is connected to the frame 40. The temperature control component 30 is provided on the heat dissipater 90. The carrying module 10 is provided on a side of the temperature control component 30 away from the heat dissipater 90. The heat dissipater 90 is configured to perform heat dissipation on the temperature control component 30. The heat dissipater 90 can transfer the heat generated by the temperature control component 30 to the external to cool the carrying module 10.

In an embodiment, the detection device further includes a pressing frame 110. The pressing frame 100 is provided on the carrying module 10 and is connected to the heat dissipater 90. The pressing frame 100 is configured to enable the carrying module 10, the temperature control component 30 and the heat dissipater 90 to be in close contact. Such arrangement can ensure a high heat transfer efficiency among the carrying module 10, the temperature control component 30 and the heat dissipater 90, so that the carrying module 10 can be quickly heated and cooled, and the samples can react quickly to improve the detection efficiency.

Described above are only preferred embodiments of the present disclosure, which are not intended to limit the scope of the present disclosure. Any changes, equivalent modifications and improvements based on the concept of the present disclosure and uses in all other related technical fields, shall fall within the protection scope of the present disclosure.

What is claimed is:

1. A carrying module, comprising:
a main body;
wherein a top of the main body is provided with a plurality of cavities; the plurality of cavities is configured to accommodate a sample; a side of the main body is provided with a plurality of channels; and the plurality of channels communicates with the plurality of cavities in one-to-one correspondence.

2. The carrying module of claim 1, wherein the plurality of cavities comprises a plurality of first cavities and a plurality of second cavities; the plurality of first cavities and the plurality of second cavities are both provide along a length of the main body; the plurality of first cavities and the plurality of second cavities are provided in parallel and are misaligned; the plurality of channels is provided along the length of the main body; and the plurality of channels alternately communicates with the plurality of first cavities and the plurality of second cavities in one-to-one correspondence.

3. The carrying module of claim 2, wherein the plurality of first cavities is arranged spaced apart; the plurality of second cavities is arranged spaced apart; and the plurality of first cavities and the plurality of second cavities are alternately arranged.

4. The carrying module of claim 3, wherein the plurality of channels comprises a plurality of first channels and a plurality of second channels; the plurality of first channels and the plurality of second channels are both provided spaced apart; the plurality of first channels and the plurality of second channels are alternately provided; the plurality of first channels communicates with the plurality of first cavities in one-to-one correspondence; and the plurality of second channels communicates with the plurality of second cavities in one-to-one correspondence.

5. The carrying module of claim 2, wherein the main body comprises a front portion and a rear portion connected with each other; the front portion comprises an upper portion and a lower portion connected with each other; the upper portion comprises a plurality of first cylinders connected in sequence; a plurality of first sub-cavities with a top opening is provided on the plurality of first cylinders, respectively; the lower portion comprises a plurality of second sub-cavities spaced apart; the plurality of first sub-cavities communicates with the plurality of second sub-cavities in one-to-one correspondence to form the plurality of first cavities; the rear portion comprises a plurality of second cylinders connected in sequence; the plurality of second cylinders is respectively provided with a top opening to form the plurality of second cavities; and the plurality of channels is provided on a side of the lower portion.

6. A detection device, comprising:
the carrying module of claim 5;
a plurality of light guide columns;
a temperature control component;
a frame;
a detecting unit; and
a drive unit;
wherein the plurality of light guide columns is provided in the channels communicating with the plurality of second cavities in one-to-one correspondence; and the plurality of light guide columns is configured to guide fluorescent signals generated by samples in the plurality of second cavities to a side of the main body, respectively;
the temperature control component is configured to heat or cool the carrying module to adjust a temperature of the samples;
the detecting unit is configured to detect the fluorescent signals generated by the samples; and
the drive unit is provided on the frame; the drive unit is configured to drive the detecting unit to move along the length of the main body to enable the detecting unit to detect fluorescent signals generated by samples in the plurality of first cavities and/or in the plurality of second cavities.

7. The detection device of claim 6, further comprising:
a guide member;
wherein the guide member is configured to guide the detecting unit to move along the length of the main body when the detecting unit is driven by the drive unit.

8. The detection device of claim 7, wherein the guide member comprises a guide rail and a sliding block provided on the guide rail; the sliding block is configured to move along the guide rail; the guide rail is provided adjacent to the front portion of the main body and in parallel with the side of the main body; the detecting unit is provided on the sliding block; the drive unit drives the detecting unit to move to enable the detecting unit to drive the sliding block to move on the guide rail such that the detecting unit moves along the length of the main body.

9. The detection device of claim 8, wherein the drive unit comprises a first driving wheel, a second driving wheel, a transmission belt and a motor; the first driving wheel, the second driving wheel and the transmission belt are provided on a top of the frame; the motor is provided on a bottom of the frame; the transmission belt is provided on the first driving wheel and the second driving wheel; the motor is connected to the first driving wheel; the transmission belt is connected to the detecting unit; the motor is configured to drive the first driving wheel to rotate; the first driving wheel drives the transmission belt to move such that the transmission belt drives the detecting unit to move, driving the sliding block to move along the guide rail.

10. The detection device of claim 9, further comprising:
a limit assembly;
wherein the limit assembly is configured to limit a movement range of the detecting unit along the guide rail.

11. The detection device of claim 10, wherein the limit assembly comprises a first limit part and a second limit part; the first limit part and the second limit part are provided on two sides of the guide rail, respectively, to limit the movement range of the detecting unit along the guide rail.

12. The detection device of claim 6, further comprising:
a heat dissipater;
wherein the heat dissipater is connected to the frame; the temperature control component is provided on the heat dissipater; the carrying module is provided on a side of the temperature control component away from the heat dissipater; and the heat dissipater is configured to perform heat dissipation on the temperature control component.

13. The detection device of claim 12, further comprising:
a pressing frame;
wherein the pressing frame is provided on the carrying module and is connected to the heat dissipater; and the pressing frame is configured to enable the carrying module, the temperature control component and the heat dissipater to be in close contact.
